(19) United States
(12) Patent Application Publication
(10) Pub. No.: US 2026/0064796 A1
(43) Pub. Date: Mar. 5, 2026

(54) HYBRID QUANTUM-CLASSICAL COMPUTING APPARATUS WITH OPTIMIZATION PROBLEM SOLVING

(71) Applicant: Samsung Electronics Co., Ltd., Suwon-si (KR)

(72) Inventor: Whan GHANG, Suwon-si (KR)

(73) Assignee: Samsung Electronics Co., Ltd., Suwon-si (KR)

(21) Appl. No.: 18/782,583

(22) Filed: Jul. 24, 2024

(30) Foreign Application Priority Data
Mar. 4, 2024 (KR) 10-2024-0030756

(51) Int. Cl. G06F 17/11

(52) U.S. Cl. CPC G06F 17/11

(57) ABSTRACT

The present disclosure relates to obtaining an enforced solution of a combinatorial optimization problem by a hybrid quantum-classical computing apparatus. The method of obtaining an enforced solution of a combinatorial optimization problem is performed by a hybrid quantum-classical computing apparatus that includes a classical computer and a quantum computer, and the method includes: by the classical computer, storing a representation of a combinatorial optimization problem that is to be solved; by the quantum computer, obtaining a solution of the combinatorial optimization problem using a quantum algorithm; and by the classical computer, improving the solution, obtained using the quantum algorithm, by executing a greedy algorithm to obtain an enforced solution based on the solution of the combinatorial optimization problem.

### CROSS-REFERENCE TO RELATED APPLICATIONS

This application claims priority from Korean Patent Application No. 10-2024-0030756, filed on Mar. 4, 2024, in the Korean Intellectual Property Office, the entire disclosure of which is incorporated herein by reference for all purposes.

### BACKGROUND

### 1. Field

The following description relates to technology for solving a solution of a combinatorial optimization problem, and more particularly, to technology for enforcing a solution of a quantum optimization problem using a classical greedy method.

### 2. Description of Related Art

Recently, with the development in quantum computing technology, there is a growing interest in using quantum devices for solving complex combinatorial optimization problems. In classical computing, by using an exhaustive search method to solve a combinatorial optimization problem, it is possible to find an exact solution with 100% accuracy, but assuming that there are n variables in, for example, a quadratic unconstrained binary optimization (QUBO) problem, an objective function is calculated by searching for 2″ number of cases and performing calculations O(n²) number of times for each case, such that a total time complexity increases exponentially to O(n²2^{N}). In quantum computing, a quantum algorithm such as the Variational Quantum Eigensolver (VQE) or Quantum Approximate Optimization Algorithm (QAOA) may be used to obtain an optimal solution. With a quantum algorithm, unlike with classical computing, time complexity is polynomial with respect to the number of variables, such that the optimal solution may be obtained within a desired time. However, while the exact solution may be obtained by a classical exhaustive search method, a quantum algorithm may not ensure the accuracy of the solution.

### SUMMARY

In one general aspect, a method of obtaining an enforced solution of a combinatorial optimization problem is performed by a hybrid quantum-classical computing apparatus that includes a classical computer and a quantum computer, and the method includes: by the classical computer, storing a representation of a combinatorial optimization problem that is to be solved; by the quantum computer, obtaining a solution of the combinatorial optimization problem using a quantum algorithm; and by the classical computer, improving the solution, obtained using the quantum algorithm, by executing a greedy algorithm to obtain an enforced solution based on the solution of the combinatorial optimization problem.

The combinatorial optimization problem may include a Quadratic unconstrained binary optimization (QUBO) problem or a maximum cut (Max-Cut) problem.

The method may further included, by the classical computer: transforming the defined combinatorial optimization problem into an Ising model; and creating a Hamiltonian of the Ising model.

The method may further include forming an Ansatz by the classical computer, and wherein the solution of the combinatorial optimization problem is obtained based on the formed Ansatz by using a Quantum Approximate Optimization Algorithm (QAOA) or a Variational Quantum Eigensolver (VQE).

The solution of the combinatorial optimization problem may be obtained based on the created Hamiltonian by using Quantum Annealing performed by the quantum computer.

The obtaining of the enforced solution by using the greedy algorithm may include, in response to a value that increases an objective function value being output by executing the greedy algorithm for each of pairs of solutions obtained using the quantum algorithm, replacing the solutions of each of the pairs with the output value.

The obtaining of the enforced solution by using the greedy algorithm may include, in response to a value that increases an objective function value being output by sorting solutions, obtained using the quantum algorithm, based on a weight of the objective function, and by executing the greedy algorithm for each of pairs of the sorted solutions, replacing the solution of each of the pairs with the output value.

A computer-readable recording medium may have stored thereon instructions configured to implement any of the methods.

In another general aspect, a hybrid quantum-classical computing apparatus includes: a classical computer including a classical processor and a memory storing instructions, wherein the classical processor is a non-quantum processor; and a quantum computer configured to be in communication with the classical computer, wherein the instructions, when executed by the classical processor, perform a process including: obtaining a solution of the combinatorial optimization problem using a quantum algorithm by the quantum computer, and improving the solution, obtained using the quantum algorithm, by executing a greedy algorithm to obtain, based on the solution of the combinatorial optimization problem, an enforced solution by the classical computer.

The combinatorial optimization problem may include a Quadratic unconstrained binary optimization (QUBO) problem or a maximum cut (Max-Cut) problem.

The process may further include, by the classical computer, according to the one or more instructions: transforming the defined combinatorial optimization problem into an Ising model; and creating a Hamiltonian of the Ising model.

The process may further include forming an Ansatz by the classical computer according to the instructions, wherein the solution of the combinatorial optimization problem is obtained based on the formed Ansatz by using a Quantum Approximate Optimization Algorithm (QAOA) or a Variational Quantum Eigensolver (VQE).

The solution of the combinatorial optimization problem may be obtained based on the created Hamiltonian by using Quantum Annealing performed by the quantum computer.

The obtaining of the enforced solution may include, in response to a value that increases an objective function value being output by executing a greedy algorithm for each of pairs of solutions obtained using the quantum algorithm, replacing the solutions of each of the pairs with the output value.

The obtaining of the enforced solution may include, in response to a value that increases an objective function value being output by sorting solutions, obtained using the quantum algorithm, based on a weight of the objective function, and by executing the greedy algorithm for each of pairs of the sorted solutions, replacing the solution of each of the pairs with the output value.

In another general aspect, an electronic device includes: a memory storing instructions; a greedy post-processor including a greedy algorithm configured according to the instructions; and one or more non-quantum processors configured to, according to the instructions, store a representation of a combinatorial optimization problem that is to be solved, instruct a quantum computer to obtain a solution of the combinatorial optimization problem by using a quantum algorithm, and control the greedy post-processor to improve the solution, obtained using the quantum algorithm, to obtain an enforced solution based on the solution of the combinatorial optimization problem.

In response to a value that increases an objective function value being output by executing a greedy algorithm for each of pairs of solutions obtained using the quantum algorithm, the greedy post-processor may be configured to replace the solution of each of the pairs with the output value.

In response to a value that increases an objective function value being output by sorting solutions, obtained using the quantum algorithm, based on a weight of the objective function, and by executing the greedy algorithm for each of pairs of the sorted solutions, the greedy post-processor may be configured to replace the solution of each of the pairs with the output value.

Other features and aspects will be apparent from the following detailed description, the drawings, and the claims.

### BRIEF DESCRIPTION OF THE DRAWINGS

FIG. 1 illustrates a hybrid quantum-classical computing apparatus, according to one or more embodiments.

FIG. 2A illustrates a quantum computer, according to one or more embodiments.

FIG. 2B illustrates a classical computer, according to one or more embodiments.

FIG. 3 illustrates an example of a Quantum Approximate Optimization Algorithm (QAOA), according to one or more embodiments.

FIG. 4 illustrates obtaining an improved solution of a combinatorial optimization problem, according to one or more embodiments.

FIGS. 5A and 5B illustrate obtaining an improved solution of a combinatorial optimization problem, according to one or more embodiments.

FIG. 6 illustrates an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

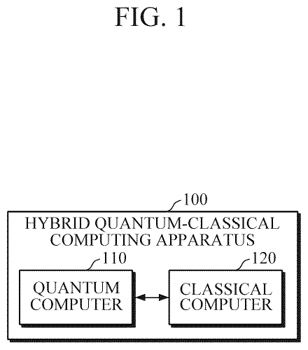

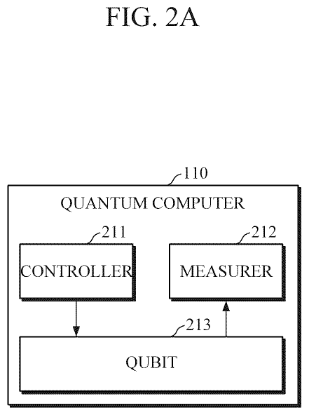

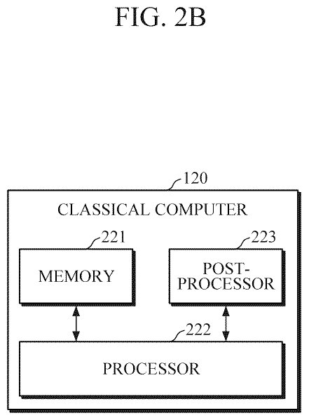

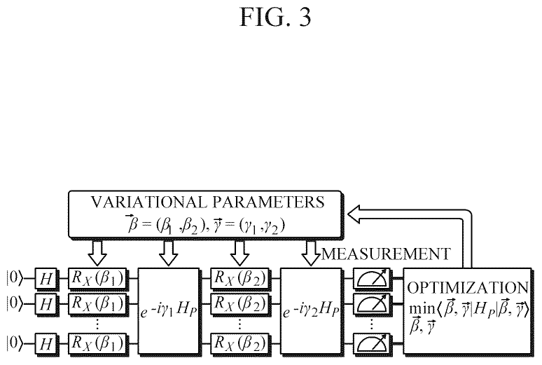

FIG. 1 illustrates a hybrid quantum-classical computing apparatus, according to one or more embodiments. FIG. 2A illustrates a quantum computer, according to one or more embodiments. FIG. 2B illustrates a classical computer, according to one or more embodiments. FIG. 3 illustrates an example of a general Quantum Approximate Optimization Algorithm (QAOA), according to one or more embodiments.

Referring to FIG. 1, a hybrid quantum-classical computing apparatus 100 may include a quantum computer 110 and a classical computer 120, and may obtain an enforced solution of a combinatorial optimization problem by using the quantum and classical computers. The classical computer 120 may define a combinatorial optimization problem to be solved, and the quantum computer 110 may obtain an enforced solution by post-processing the solution, obtained using a quantum algorithm, by executing a greedy algorithm.

The combinatorial optimization problem may be, for example, a Quadratic Unconstrained Binary Optimization (QUBO) problem, or other optimization problems, such as a maximum cut (Max-Cut) problem, which may be transformed into the QUBO problem. The QUBO problem is a problem of finding n number of bits x₁, x₂, . . . , xₙ ∈{0, 1} that maximizes or minimizes a quadratic objective function

$${\sum }_{1 \leq i , j \leq n} {a}_{ij} {x}_{i} {x}_{j} ,$$

when real numbers aᵢⱼ(1≤i, j≤n) are given as input. Here, minimizing the above objective function for {aᵢⱼ} is equivalent to maximizing the above objective function for {−aᵢⱼ}, and thus is equivalent to solving the problem of maximizing the objective function.

Referring to FIG. 2A, the quantum computer 110 includes a controller 211, a measurer 212, and qubits 213.

The quantum computer 110 may include quantum objects, such as atoms, ions, neutrons, protons, photons, electrons, etc., and states of the quantum objects may be represented as quantum bits or the qubits 213, the equivalent of bits in the classical computer, in terms of information processing. The quantum computer 110 may perform information processing on the quantum objects by using a quantum mechanical phenomenon of entanglement, for example.

The controller 211 may include various quantum technologies, such as superconducting technology, ion trap technology, optical technology, etc., without particular limitation, and may control the quantum states of the quantum objects by using these quantum technologies. Here, the quantum technologies may include any techniques for creating quantum objects using quantum mechanics, and are not limited to the above quantum technologies. The controller 211 may change phase states of the quantum objects in the quantum computer 110. The controller 211 may perform a controlling operation by outputting a control signal to qubits 213. The control signal may be various types of control signals, such as an electric signal, a magnetic signal, an optical signal (e.g., laser pulse), or any combination thereof, such as an electromagnetic signal of any type, that is capable of controlling the state of a qubit 213. The control signal may include a state Ready signal for changing states for all or part of the qubit 213.

The measurer 212 may measure the changed phase information of the quantum object, and may transform a result of quantum processing into classical data. The measurement process may be repeated.

For example, the quantum computer 110 may be a gate-based quantum computer including one or more quantum gates constituting a quantum circuit. The gate-based quantum computer 110 may obtain a solution of a combinatorial optimization problem to be solved using a quantum algorithm, such as the Quantum Approximate Optimization Algorithm (QAOA) or Variational Quantum Eigensolver (VQE), as non-limiting examples.

In another example, the quantum computer 110 is not necessarily limited to the gate-based quantum computer, and the quantum computer 110 may be/include a quantum annealer which is implemented using all or part of a quantum annealing architecture. Quantum annealing (QA) involves using metaheuristics for finding the global minimum of a given objective function over a given set of candidate solutions (candidate states), by a process using quantum fluctuations. The quantum computer 110 may obtain a solution of a combinatorial optimization problem by using a quantum annealing algorithm.

Referring to FIG. 2B, the classical computer 120 may include a memory 221, a classical processor 222, and a greedy post-processor 223. For example, the classical computer 120 may be a Von Neumann architecture or, more broadly, any digital non-quantum computer.

The memory 221 may store one or more computer instructions. The instructions may be permanently or temporarily stored in the memory 221. When executed by the classical processor 222, the instructions may implement a method of obtaining a solution of a combinatorial optimization problem. The instructions may be characterized by a program for solving the combinatorial optimization problem, a software program (in the form of instructions/code), and the like. The method of solving a combinatorial optimization problem may include (i) defining a combinatorial optimization problem to be solved and (ii) instructing a quantum computer to solve the defined combinatorial optimization problem by using a quantum algorithm. In addition, the method may include transforming the defined combinatorial optimization problem into an Ising model, creating a Hamiltonian, and/or forming an Ansatz. In addition, the method may include controlling a greedy post-processor 223 to obtain an improved solution.

The memory 221 may include a Random Access Memory (RAM), such as a Dynamic Random Access Memory (DRAM), a Static Random Access Memory (SRAM), etc., a Read-Only Memory (ROM), a flash memory, a cache memory, a virtual memory, etc., but is not limited thereto.

The classical processor 222 may read and execute instructions and/or data by referring to the memory 221, and may store processed data in the memory 221 or output the data through an output device. The classical processor 222 may communicate with other components of the classical computer 120 through an internal bus. The classical processor 222 may receive a user input through a mouse, a keyboard, or any other input device and may process the user input.

FIG. 3 illustrates an example of a general Quantum Approximate Optimization Algorithm (QAOA), according to one or more embodiments.

The general QAOA algorithm uses quantum gates parameterized by variational parameters γ and β. The gates may include a gate Rₓ(β) from Mixer Hamiltonians and a gate e^{-iγH}^{ₚ} from Problem Hamiltonians. The quantum computer 110 may obtain an expected value by measuring qubits, and the classical computer 120 may obtain an approximate optimal solution of the objective function by optimizing parameters γ and β.

Referring back to FIG. 2B, the greedy post-processor 223 may include a greedy algorithm. Once the quantum computer 110 obtains a solution of the combinatorial optimization problem using a quantum algorithm (e.g., QAOA), the greedy post-processor 223 may improve the solution (which has been obtained using the quantum algorithm) by executing the greedy algorithm to obtain an enforced solution. The greedy post-processor 223 may be implemented in software and/or hardware, and may also be implemented as part of the function of the classical processor 220. The greedy post-processor 223 may also search for a point far from a position near a starting point of the solution, such that if there are continuous changes, it is possible to find a relatively further improved solution compared to a search of a starting near the solution.

For example, when solutions of a QUBO maximization problem are (x₁, x₂, . . . , xₙ), which are obtained by the quantum computer 110 using the quantum algorithm, and when xᵢ∈{0, 1}, an objective function is calculated by inputting, to the greedy algorithm, values other than a current value among (0,0), (0,1), (1,0), and (1,1) for all solution pairs (xᵢ,xⱼ), and if a value of the objective function which is a maximum value is output, the solution pair (xᵢ,xⱼ) may be replaced with the output maximum value. For example, when the value of the current solution pair (x₂,x₄) is (0,1) and a value of the objective function is 90, if values (0,0), (1,0), and (1,1) are input, and values of the objective function are 78, 89, and 100 which are obtained while other variables remain unchanged, the value of (x₂,x₄) is replaced with (1,1), the solution pair of the maximum value.

In this case, the number of all pairs (xᵢ,xᵢ) is O(n²), and time complexity is O(n⁴) as the number is also O(n²) when a value of the objective function is obtained. This is polynomial time which is faster than exponential time O(n²2ⁿ) of a typical classical method, such that the execution time may be reduced compared to classical exhaustive search. However, when the objective function value is calculated by changing values of two different points, only the line segments (edges) with the two points are updated to calculate the objective function value, such that time complexity may also be reduced to O(n³). In addition, when an average number of neighbors of points satisfies O(1), time complexity may be further reduced to O(n²).

If a value that increases the objective function value is output by sorting the solutions (obtained using the quantum algorithm) in ascending order based on the weight (e.g., aᵢⱼ in the objective function of the above QUBO) of the objective function, and by executing the greedy algorithm starting from pairs with small weights, the solution of each of the pairs may be replaced with the output value.

With this approach, the method of providing an improved solution to a combinatorial optimization problem may be used in applications which may be reduced to an optimization problem, such as VLSI chip design, antenna design, and the like. In addition, the method may be applied to the Quadratic Assignment Problem (QAP) which may be used for optimizing placement of facilities, etc., and for designing position of factories, hospitals, industrial plants, network models, transportation infrastructure, military bases, and the like.

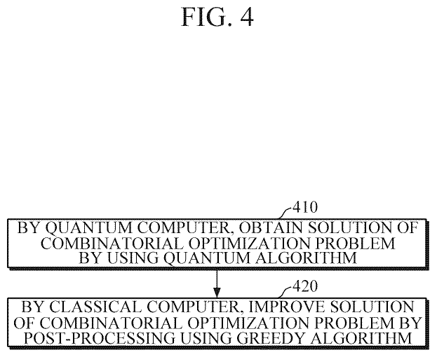

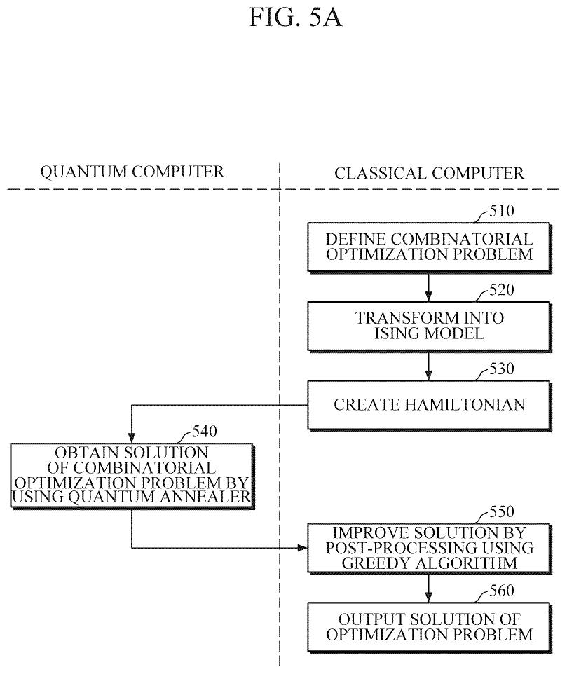

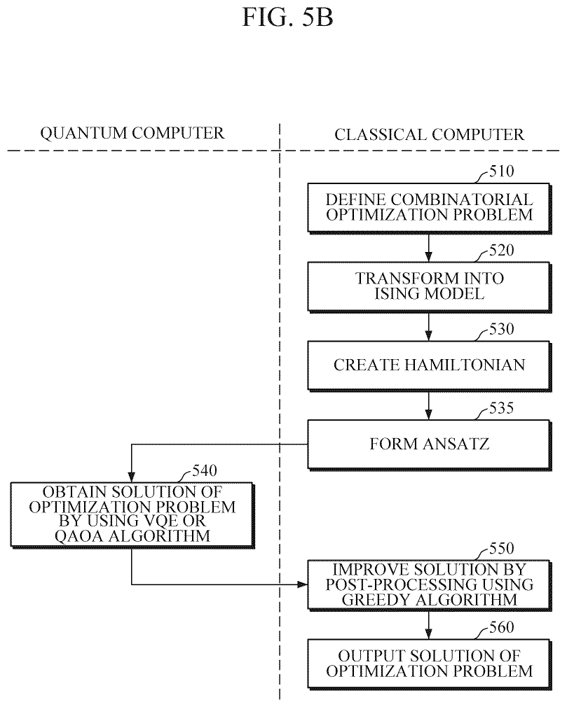

FIG. 4 illustrates a method of obtaining an improved solution of a combinatorial optimization problem, according to one or more embodiments. FIGS. 5A and 5B illustrate obtaining an improved solution of a combinatorial optimization problem according to detailed embodiments of the present disclosure.

Referring to FIG. 4, the method of obtaining an improved solution of a combinatorial optimization problem may be performed by the hybrid quantum-classical computing apparatus FIG. 1.

The hybrid quantum-classical computing apparatus may obtain a solution of a combinatorial optimization problem by using a quantum algorithm in the quantum computer in 410, and then may improve the solution of the combinatorial optimization problem, which is obtained using the quantum algorithm, by executing the greedy algorithm in the classical computer in 420. In this case, the combinatorial optimization problem may include, for example, the Quadratic Unconstrained Binary Optimization (QUBO) problem, and various optimization problems, such as the maximum cut (Max-Cut) problem which may be transformed into the Quadratic Unconstrained Binary Optimization (QUBO) problem. The quantum algorithm may include a quantum annealing algorithm, or a hybrid quantum-classical algorithm such as approximate QAOA or VQE using quantum annealing as a gate-based circuit.

Referring to FIG. 5A, the classical computer may first define a combinatorial optimization problem to be solved in 510, may transform the defined combinatorial optimization problem into an Ising model in 520, and may create a Hamiltonian in 530.

Then, the quantum computer may obtain a solution of the combinatorial optimization problem defined in 540 by starting the quantum annealing using the Hamiltonian provided by the classical computer. By setting quantum bits to an initial state, the quantum computer may perform quantum annealing by using the Hamiltonian. A quantum state evolves over time as the Hamiltonian is applied over time, and after performing quantum annealing for a predetermined period of time, the quantum computer may measure a final quantum state to obtain the solution.

Then, the classical computer may improve the solution, obtained in 540, by using the greedy algorithm in 550. An objective function is calculated by inputting, to the greedy algorithm, values other than a current value among (0,0), (0,1), (1,0), and (1,1) for all pairs of solutions obtained using the quantum algorithm. If an output value of the objective function is a maximum value, the value of the current pair may be replaced with the output value. In this case, solutions obtained using the quantum algorithm are sorted in ascending order based on the weight of the objective function, and the greedy algorithm may be executed starting from pairs with small weights.

Then, the classical computer may output the obtained solution of the combinatorial optimization problem in 560.

Referring to FIG. 5B, the classical computer may define a combinatorial optimization problem to be solved in 510, may transform the defined combinatorial optimization problem into an Ising model in 520, may create a Hamiltonian in 530, and may form an Ansatz that represents a parameter or form of a quantum circuit in 535. The Ansatz may represent the form of a quantum circuit selected depending on optimization problems. The quantum circuit represents a sequence of gates and connections between quantum bits, and may be changed to various forms by adjusting parameters of the Ansatz.

Then, the gate-based quantum computer may obtain a solution of the combinatorial optimization problem in 540 by using the Ansatz formed in operation 540. For example, a quantum circuit may be formed using the Ansatz, and parameters of the Ansatz may be optimized using an optimization algorithm such as QAOA, VQE, and the like. By measuring and interpreting the state of quantum bits obtained using the optimized Ansatz, a solution of the optimization problem may be obtained.

Then, the classical computer obtains an enforced solution for the solution, obtained in 540, by executing the greedy algorithm in 550, and may output the solution of the optimization problem in 560.

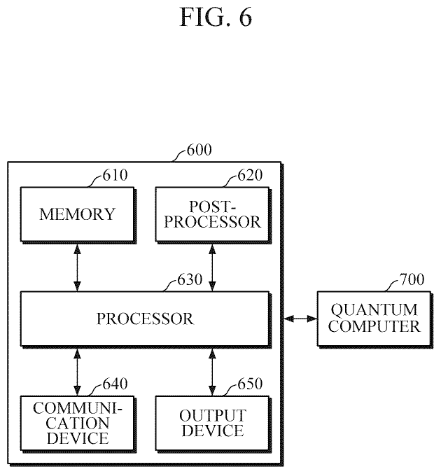

FIG. 6 illustrates an electronic device, according to one or more embodiments.

An electronic device 600 may include the aforesaid classical computer. The electronic device 600 may be, for example, servers, cloud computers, desktop computers, various types of wearable devices such as smart watches, smart bands, smart glasses, smart earphones, smart rings, smart patches, and smart necklaces, and mobile devices such as smartphones, tablet PCs, etc., or various Internet of Things (IoT) devices (e.g., home IoT devices, etc.) based on IoT technology. However, the electronic device 600 is not limited thereto, and may include various information processing devices.

Referring to FIG. 6, the electronic device 600 may include a memory 610, a greedy post-processor 620, a processor 630, a communication device 640, and an output device 650. Further, the electronic device 600 may further include an image capture device for acquiring images, a sensor device (e.g., acceleration sensor, gyroscope, magnetic field sensor, proximity sensor, illuminance sensor, fingerprint sensor, etc.) for detecting various data, an input device (e.g., a microphone, a mouse, a keyboard, and/or a digital pen (e.g., a stylus pen, etc.), etc.) for receiving instructions and/or data to be used from a user, and the like.

The memory 610 may store various instructions executed by the processor 630 and/or various data related to an optimization problem. The memory 610 may include a Random Access Memories (RAM), such as a Dynamic Random Access Memory (DRAM), a Static Random Access Memory (SRAM), etc., a Read-Only Memory (ROM), a flash memory, a cache memory, a virtual memory, etc., but is not limited thereto.

The greedy post-processor 620 may include a greedy algorithm (e.g., a processor, or the processor 630, as configured according to instructions configured as described above). Once a quantum computer 700 obtains a solution of a combinatorial optimization problem by using a quantum algorithm (e.g., QAOA), the greedy post-processor 620 may improve the solution, obtained using the quantum algorithm, by executing the greedy algorithm to obtain an enforced solution. The greedy post-processor 620 may be implemented in software and/or hardware, and may also be implemented as part of the function of the processor 630.

The processor 630 may execute instructions stored in the memory 610 in response to a user's request, to perform operations, such as defining a combinatorial optimization problem to be solved, transforming into an Ising model, creating a Hamiltonian, and/or forming an Ansatz, etc., and may transmit results thereof to the quantum computer 700 through the communication device 640, so as to instruct the quantum computer 700 to obtain a solution of the defined combinatorial optimization problem. In addition, upon receiving the solution of the defined combinatorial optimization problem from the quantum computer 700, the processor 630 may control the greedy post-processor 620 to improve the solution of the defined combinatorial optimization problem which is obtained by the quantum computer 700 using the quantum algorithm. The processor 630 may include a main processor, e.g., a central processing unit (CPU) or an application processor (AP), etc., an intellectual property (IP) core, and an auxiliary processor, e.g., a graphics processing unit (GPU), an image signal processor (ISP), a sensor hub processor, or a communication processor (CP), etc., which is operable independently from, or in conjunction with, the main processor, and the like.

The communication device 640 may support establishment of a direct (e.g., wired) communication channel and/or a wireless communication channel between the electronic device and the quantum computer 700 or other electronic device, a server, or the sensor device within a network environment, and performing of communication via the established communication channel, by using various communication techniques. The communication techniques may include various wired or wireless communication techniques, such as Bluetooth communication, Bluetooth Low Energy (BLE) communication, Near Field Communication (NFC), WLAN communication, Zigbee communication, Infrared Data Association (IrDA) communication, Wi-Fi Direct (WFD) communication, Ultra-Wideband (UWB) communication, Ant+ communication, WIFI communication, Radio Frequency Identification (RFID) communication, 3G, 4G, and 5G communications, direct connection via an internal bus, and the like.

The output device 650 may visually/non-visually output various data (e.g., enforced solution of the combinatorial optimization problem) processed by the processor 630. The output device 650 may include a sound output device, a display device (e.g., display), an audio module, and/or a haptic module.

The computing apparatuses, the electronic devices, the memories, the quantum devices, the displays, the information output system and hardware, the storage devices, and other apparatuses, devices, units, modules, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of obtaining an enforced solution of a combinatorial optimization problem by a hybrid quantum-classical computing apparatus comprising a classical computer and a quantum computer, the method comprising:
by the classical computer, storing a representation of a combinatorial optimization problem that is to be solved;
by the quantum computer, obtaining a solution of the combinatorial optimization problem using a quantum algorithm; and
by the classical computer, improving the solution, obtained using the quantum algorithm, by executing a greedy algorithm to obtain an enforced solution based on the solution of the combinatorial optimization problem.

2. The method of claim 1, wherein the combinatorial optimization problem comprises a Quadratic unconstrained binary optimization (QUBO) problem or a maximum cut (Max-Cut) problem.

3. The method of claim 1, further comprising, by the classical computer:
transforming the defined combinatorial optimization problem into an Ising model; and
creating a Hamiltonian of the Ising model.

4. The method of claim 3, further comprising forming an Ansatz by the classical computer, and
wherein the solution of the combinatorial optimization problem is obtained based on the formed Ansatz by using a Quantum Approximate Optimization Algorithm (QAOA) or a Variational Quantum Eigensolver (VQE).

5. The method of claim 3, wherein the solution of the combinatorial optimization problem is obtained based on the created Hamiltonian by using Quantum Annealing performed by the quantum computer.

6. The method of claim 1, wherein the obtaining of the enforced solution by using the greedy algorithm comprises, in response to a value that increases an objective function value being output by executing the greedy algorithm for each of pairs of solutions obtained using the quantum algorithm, replacing the solutions of each of the pairs with the output value.

7. The method of claim 1, wherein the obtaining of the enforced solution by using the greedy algorithm comprises, in response to a value that increases an objective function value being output by sorting solutions, obtained using the quantum algorithm, based on a weight of the objective function, and by executing the greedy algorithm for each of pairs of the sorted solutions, replacing the solution of each of the pairs with the output value.

8. A computer-readable recording medium having stored thereon instructions configured to implement the method of claim 1.

9. A hybrid quantum-classical computing apparatus comprising:
a classical computer including a classical processor and a memory storing instructions, wherein the classical processor is a non-quantum processor; and
a quantum computer configured to be in communication with the classical computer,
wherein the instructions, when executed by the classical processor, perform a process comprising:
obtaining a solution of the combinatorial optimization problem using a quantum algorithm by the quantum computer, and
improving the solution, obtained using the quantum algorithm, by executing a greedy algorithm to obtain, based on the solution of the combinatorial optimization problem, an enforced solution by the classical computer.

10. The apparatus of claim 9, wherein the combinatorial optimization problem comprises a Quadratic unconstrained binary optimization (QUBO) problem or a maximum cut (Max-Cut) problem.

11. The apparatus of claim 9, wherein the process further comprises, by the classical computer, according to the one or more instructions:
transforming the defined combinatorial optimization problem into an Ising model; and
creating a Hamiltonian of the Ising model.

12. The apparatus of claim 11, wherein the process further comprises forming an Ansatz by the classical computer according to the instructions,
wherein the solution of the combinatorial optimization problem is obtained based on the formed Ansatz by using a Quantum Approximate Optimization Algorithm (QAOA) or a Variational Quantum Eigensolver (VQE).

13. The apparatus of claim 11, wherein the solution of the combinatorial optimization problem is obtained based on the created Hamiltonian by using Quantum Annealing performed by the quantum computer.

14. The apparatus of claim 9, wherein the obtaining of the enforced solution comprises, in response to a value that increases an objective function value being output by executing a greedy algorithm for each of pairs of solutions obtained using the quantum algorithm, replacing the solutions of each of the pairs with the output value.

15. The apparatus of claim 10, wherein the obtaining of the enforced solution comprises, in response to a value that increases an objective function value being output by sorting pairs of solutions, obtained using the quantum algorithm, based on a weight of the objective function, and by executing the greedy algorithm for each of the sorted pairs of solutions, replacing the solution of each of the pairs with the output value.

16. An electronic device comprising:
a memory storing instructions;
a greedy post-processor comprising a greedy algorithm configured according to the instructions; and
one or more non-quantum processors configured to, according to the instructions, store a representation of a combinatorial optimization problem that is to be solved, instruct a quantum computer to obtain a solution of the combinatorial optimization problem by using a quantum algorithm, and control the greedy post-processor to improve the solution, obtained using the quantum algorithm, to obtain an enforced solution based on the solution of the combinatorial optimization problem.

17. The electronic device of claim 16, wherein in response to a value that increases an objective function value being output by executing a greedy algorithm for each of pairs of solutions obtained using the quantum algorithm, the greedy post-processor is configured to replace the solution of each of the pairs with the output value.

18. The electronic device of claim 16, wherein in response to a value that increases an objective function value being output by sorting solutions, obtained using the quantum algorithm, based on a weight of the objective function, and by executing the greedy algorithm for each of pairs of the sorted solutions, the greedy post-processor is configured to replace the solution of each of the pairs with the output value.
